(19) United States
(12) Patent Application Publication
(10) Pub. No.: US 2016/0212536 A1
(43) Pub. Date: Jul. 21, 2016

(54) METHOD FOR CONTROLLING SOUND OUTPUT OF WEARABLE DEVICE AND VEHICLE FOR CARRYING OUT THE SAME

(71) Applicant: HYUNDAI MOTOR COMPANY, Seoul (KR)

(72) Inventors: Young Woo PARK, Yongin-si (KR); Hyun Woo LEE, Yongin-si (KR); Hae Young KWON, Suwon-si (KR); Min Hyuk OH, Seoul (KR)

(21) Appl. No.: 14/798,146

(22) Filed: Jul. 13, 2015

(30) Foreign Application Priority Data
Jan. 16, 2015 (KR) 10-2015-0008157

(51) Int. Cl. H04R 3/12; B60R 11/02

(52) U.S. Cl. CPC H04R 3/12; B60R 11/02; H04R 2420/07; H04R 2499/13; B60R 2011/0282

(57) ABSTRACT

A method for providing sound from a vehicle to a plurality of wearable devices, each having a sound output unit, includes retrieving the wearable devices in a wireless manner, receiving sound input/output setting information from the respective retrieved wearable devices, and providing sound signals selectively to the respective retrieved wearable devices in a wireless manner based on the sound input/output setting information.

### CROSS-REFERENCE TO RELATED APPLICATION

This application claims priority to and the benefit of Korean Patent Application No. 10-2015-0008157, filed on Jan. 16, 2015 in the Korean Intellectual Property Office, the disclosure of which is hereby incorporated by reference as if fully set forth herein.

### TECHNICAL FIELD

The present disclosure relates to a sound output method of a vehicle based on division of wearable devices worn by a plurality of passengers and a vehicle capable of carrying out the same.

### BACKGROUND

Conventional vehicles are devised to control sound based on positions of front seat and rear seat speakers. For example, when it is needed to play navigation guide voice back during media playback, for more accurate output of the guide voice, sound output is controlled such that the volume of media playback sound at a front seat where a driver sits is lowered and the volume of the navigation guide voice is raised. At this time, in the case of a rear seat having less impact on the driver, the volume of the media playback sound at a rear seat is continuously maintained rather than being lowered.

The conventional vehicle sound control method as described above, however, does not consider wearable devices that passengers individually wear. Therefore, in situations for navigation and turn-on of warning lights, it is necessary to restrict media playback sound for passengers and to make all passengers forcibly listen to the same sound.

That is, in conventional vehicles, practically, passengers should forcibly listen to a guide sound and warning sound that is required for a driver and it is impossible to allow passengers on front and rear seats to selectively play different content (music and movie) back. In particular, there is a problem of personal privacy invasion because all passengers listen to a telephone conversation when a driver makes a cell phone call via a hands-free function.

### SUMMARY

Accordingly, the present disclosure is directed to a method for controlling sound output of a wearable device and a vehicle for carrying out the same that substantially obviate one or more problems due to limitations and disadvantages of the related art.

An object of the present disclosure is to provide a vehicle capable of outputting only sound required on a per passenger basis through a wearable device and a control method thereof.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for providing sound from a vehicle to a plurality of wearable devices each having a sound output unit includes retrieving the wearable devices in a wireless manner, receiving sound input/output setting information from the respective retrieved wearable devices, and providing sound signals selectively to the respective retrieved wearable devices in a wireless manner based on the received sound input/output setting information.

In accordance with another aspect of the present disclosure, a sound provision system of a vehicle for providing sound to a plurality of wearable devices, each having a sound output unit, includes a wireless communication unit configured to retrieve the wearable devices in a wireless manner and a controller configured to control wireless provision of selective sound signals to the respective retrieved wearable devices based on sound input/output setting information received through the wireless communication unit from the respective retrieved wearable devices.

In accordance with a further aspect of the present disclosure, a wearable device configured to receive sound from a vehicle includes a sound output unit configured to output sound, a wireless communication unit to exchange data with the vehicle in a wireless manner and a controller configured to transmit sound input/output setting information to the vehicle via the wireless communication unit and to control playback of a selective sound signal through the sound output unit when the selective sound signal based on the sound input/output setting information is received from the vehicle. The sound input/output setting information includes at least one of whether an owner of each wearable device is a driver, the position of a passenger, the kind of a function to be used, and a serviceable input/output function.

It is to be understood that both the foregoing general description and the following detailed description of the present disclosure are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating an exemplary configuration of an AVN system of a vehicle according to an embodiment of the present invention;

FIG. 2 is a view illustrating an example of smart glasses applicable to embodiments of the present invention;

FIG. 3 is a view illustrating an exemplary process of performing selective sound playback between an AVN system and wearable devices according to an embodiment of the present invention;

FIG. 4 is a view illustrating exemplary implementation of selective sound output for a driver according to an embodiment of the present invention;

FIG. 5 is a view illustrating exemplary provision of a hands-free function according to an embodiment of the present invention; and

FIG. 6 is a view illustrating exemplary implementation of in-vehicle sound setting and input/output control of multiple sounds using wearable devices according to an embodiment of the present invention.

### DETAILED DESCRIPTION

Hereinafter, reference will now be made in detail to the preferred embodiments of the present invention, examples of which are illustrated in the accompanying drawings. In the drawings, the same or similar elements are denoted by the same reference numerals even though they are depicted in different drawings, and a detailed description of the same or similar elements will be omitted. The suffixes “module” and “unit” of elements herein are used for convenience of description and thus can be used interchangeably and do not have any distinguishable meanings or functions.

In addition, in the following description of the embodiments disclosed herein, a detailed description of related known technologies will be omitted when it may make the subject matter of the embodiments disclosed herein rather unclear. In addition, the accompanying drawings have been made only for a better understanding of the embodiments disclosed herein and are not intended to limit technical ideas disclosed herein, and it should be understood that the accompanying drawings are intended to encompass all modifications, equivalents and substitutions included in the sprit and scope of the present invention.

Proposed in the present invention is that, in a case in which vehicle passengers wear wearable devices, sound playback and microphone input are performed individually through the respective wearable devices. Accordingly, a vehicle is capable of performing selective input and output of required sound through use of the wearable devices of the passengers. For example, in a case in which playback of navigation guide voice is required during media playback through a speaker of an in-vehicle AVN system, the navigation guide voice may be output only from a wearable device of a driver in a state in which media playback sound through the speaker is continuously maintained.

First, a description will be given of the configuration of an apparatus for carrying out the embodiments of the present invention.

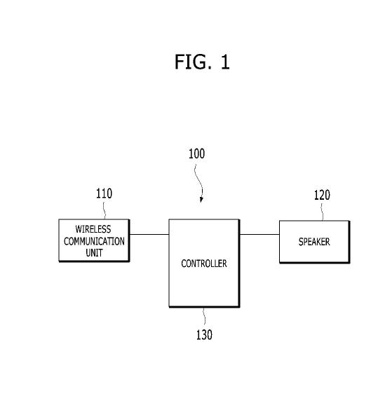

FIG. 1 is a block diagram illustrating an exemplary configuration of an audio video navigation (AVN) system of a vehicle according to an embodiment of the present invention.

Referring to FIG. 1, the AVN system, designated by reference numeral 100, of the vehicle may include a wireless communication unit 110 connected to a wearable device including a speaker and a microphone such as smart glasses via wireless communication protocols such as, for example, Bluetooth or Wi-Fi, to exchange a sound signal, a speaker 120 to output a related sound upon multimedia playback and execution of a navigation function, and a controller 130 to control the aforementioned components. The controller 130 may perform judgment and calculation required to carry out the present embodiment. For example, the controller 130 may control the overall process of establishing wireless data paths with wearable devices, divide the wearable devices connected thereto in a wireless manner from one another, and transmit only sound suitable for the user situation of each wearable device through the wireless communication unit.

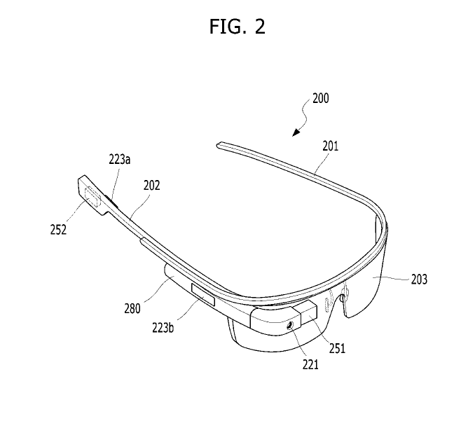

FIG. 2 is a view illustrating an example of smart glasses applicable to embodiments of the present invention.

The smart glasses 200 are configured to be worn on a human head. To this end, the smart glasses 200 may include a frame unit (e.g., a case or housing). The frame unit may be formed of a flexible material for easy wearing. FIG. 2 illustrates the frame unit as including a first frame 201 and a second frame 202 formed of different materials.

The frame unit is supported by the head and internally defines a space for installation of various components. As illustrated, electronic components such as, for example, a control module 280 and a sound output module 252 may be mounted to the frame unit. In addition, a lens 203 to cover at least one of the left eye and the right eye may be separably coupled to the frame unit.

A display unit 251 may take the form of a head mounted display (HMD). The HMD is a display that is worn on the head of a user to display an image immediately in front of the user's eyes. To provide an image immediately in front of the user's eyes when the user wears the smart glasses 200, the display unit 251 may be located to correspond to at least one of the left eye and the right eye. FIG. 2 illustrates the display unit 251 as being located to correspond to the right eye so as to output an image toward the right eye of the user.

The display unit 251 may project an image to the user's eye using a prism. In addition, the prism may be a transparent to allow the user to view both the projected image and a general forward visual range (i.e. a viewing range through the user's eyes).

As described above, the image output through the display unit 251 may overlap a general driver's field of vision.

The camera 221 is located proximate to at least one of the left eye and the right eye to capture a forward image. The camera 221 located proximate to the eye may acquire an image of a scene that the user views.

Although FIG. 2 illustrates the camera 221 as being incorporated in the control module 280, the position of the camera 221 is not limited thereto. The camera 221 may be installed to the frame unit and a plurality of cameras may be used to acquire a stereoscopic image.

The smart glasses 200 may include command input units 223a and 223b operated to receive a control command. The command input units 223a and 223b may be operated by touch or push action, for example.

The control module 280 is configured to control a variety of electronic components mounted to the smart glasses 200. For example, the control module 280 may allow establishment of a wireless data path with the AVN system of the vehicle through a wireless communication unit (not shown) of the smart glasses 200. The control module 280 may receive sound setting information and output the same to the sound output unit 252 through the established data path, or may convert sound input through a microphone into electric signals to transmit the same to the AVN system. In addition, the control module 280 may allow transmission of identification information to the AVN system, the identification information corresponding to the role or position of a passenger (for example, a driver, a passenger on a front seat, or a passenger on a rear seat) that is set via a command input unit.

Although FIG. 2 illustrates the control module 280 as being installed to one side of the frame unit around the head, the position of the control module 280 is not limited thereto.

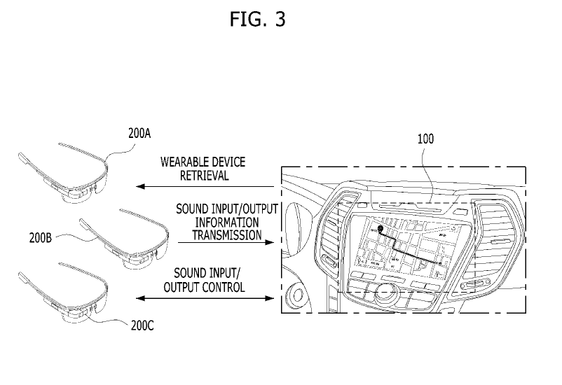

Hereinafter, implementation of selective sound playback through the above-described AVN system and wearable devices will be described with reference to FIGS. 3 to 6.

FIG. 3 is a view illustrating an exemplary process of performing selective sound playback between an AVN system and wearable devices according to an embodiment of the present invention.

Referring to FIG. 3, first, the AVN system of the vehicle retrieves wearable devices 200A, 200B and 200C possessed respectively by a plurality of passengers in the vehicle, and the respective wearable devices 200A, 200B and 200C transmit sound input/output setting information to the AVN system. Here, the sound input/output setting information may include, for example, whether an owner of the wearable device is a driver, the position of a passenger (e.g., a front passenger seat, a rear seat, or a driver seat), the kind of a function to be used (e.g., hands-free, DMB watching, navigation, and MP3 playback), serviceable input/output functions (e.g., possession of a microphone). This information may be preset in the wearable device. The wearable devices 200A, 200B and 200C are examples of the wearable devices, and the present embodiment is not limited to any particular number of the wearable devices.

The AVN system may be controlled to transmit different sounds on a per wearable device basis to correspond to individual situations of passengers and vehicle traveling conditions based on the received sound input/output setting information.

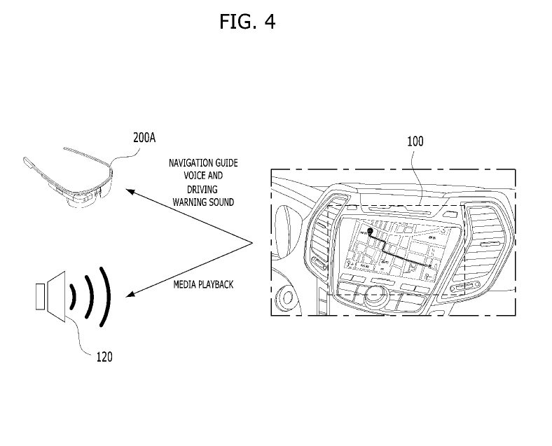

FIG. 4 is a view illustrating exemplary implementation of selective sound output for a driver according to an embodiment of the present invention.

Referring to FIG. 4, when it is necessary to play navigation guide voice and warning sound back through the speaker 120 of the AVN system 100 during media playback, the AVN system 100 may allow the navigation guide voice and warning sound to be played back through a wearable device 200A of a driver while continuously maintaining media playback through the speaker 120. As a result, it is possible to selectively provide voice guidance required only for the driver while maintaining original media playback sound.

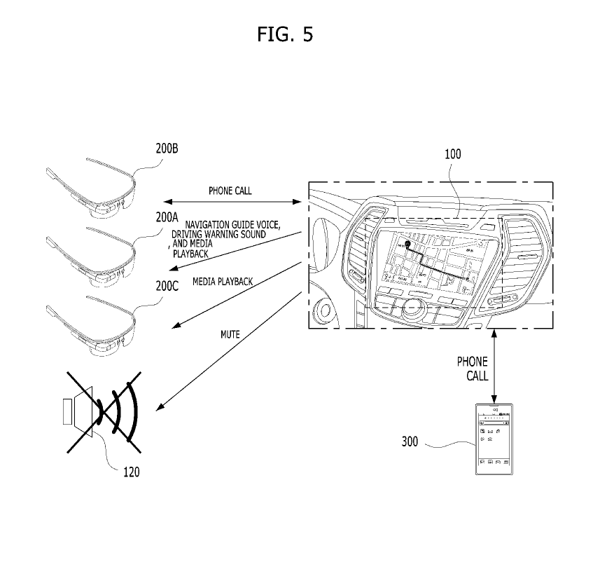

FIG. 5 is a view illustrating exemplary provision of a hands-free function according to an embodiment of the present invention.

As exemplarily illustrated in FIG. 5, in a Bluetooth-paired state between the AVN system 100 of the vehicle and a mobile phone 300, when the corresponding mobile phone 300 uses a call function, the AVN system 100 may automatically retrieve a wearable device 200B of an owner of the mobile phone 300 so as to transmit a call sound only through the corresponding wearable device 200B. Of course, the AVN system 100 may allow only navigation guide voice or warning sound to be output through a wearable device 200A of the driver, similar to FIG. 4. In addition, although the AVN system 100 functions to mute sound played back through the speaker 120 upon recognizing a current call state, the AVN system 100 may control sound to be output through a wearable device 200C of the other passenger so as to allow the passenger to continuously listen to the existing media playback sound.

In this way, the passenger who wears the wearable device 200B can make a phone call without personal privacy invasion, and even in a mute state of the speaker 120 for the phone call, the other passenger can continuously listen to existing media sound through the wearable device 200C thereof.

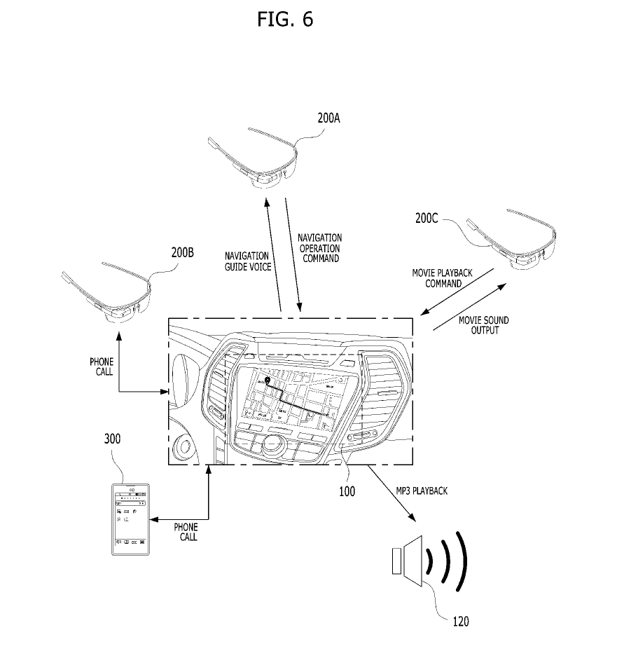

FIG. 6 is a view illustrating exemplary implementation of in-vehicle sound setting and input/output control of multiple sounds using wearable devices according to an embodiment of the present invention.

Referring to FIG. 6, in a case in which sound output of an AVN system is operated using any one wearable device in a vehicle, the operating result may be applied only to the wearable device that performs the corresponding operation. For example, when any one passenger gives a movie playback command to a wearable device 200C thereof in a state in which an MP3 file is played back through the speaker 120 of the vehicle, sound of a playback movie may be output through the corresponding wearable device 200C while the speaker 120 continuously maintains MP3 playback. In another example, when the volume of navigation guide voice is adjusted through a wearable device 200A of the driver, only the volume of the navigation guide voice output through the wearable device 200A of the driver may vary without variation in the volume of other sounds.

Accordingly, through utilization of the present technology, passengers of a vehicle can selectively use desired content individually without having an effect on the input/output state of sound from the vehicle.

As is apparent from the above description, the embodiments of the present invention provide the following advantages as compared to the related art.

First, in a case in which a driver of a vehicle wears a wearable device, an in-vehicle AVN system may allow input/output of sound required for navigation only through the wearable device of the driver.

In addition, during the input/output of sound required for navigation through the wearable device, input/output of existing media playback sound through the AVN system of the vehicle may be maintained.

In addition, when it is necessary to provide several passengers with input/output of different sounds in the case of, for example, a phone call, the input/output of sounds suitable for respective wearable devices of the passengers may be automatically controlled.

In addition, by controlling the sounds of the respective wearable devices, it is possible to allow the passengers of the vehicle to selectively use desired content individually without having an effect on the input/output of existing media playback sound through the AVN system of the vehicle.

It will be appreciated by persons skilled in the art that the effects that can be achieved through the present disclosure are not limited to what has been particularly described hereinabove and other advantages of the present disclosure will be more clearly understood from the above detailed description.

The present disclosure as described above may be implemented as a computer readable code of a computer readable medium in which programs are recorded. The computer readable medium includes all kinds of recording devices in which data that may be read by a computer system is stored. Examples of the computer readable medium may include a hard disk drive (HDD), a solid state disk (SSD), a silicon disk drive (SDD), ROM, a RAM, a CD-ROM, a magnetic tape, a floppy disk, and an optical data storage device. In addition, the computer readable recording medium includes a carrier wave (e.g., data transmission over the Internet).

Accordingly, the above detailed description is not intended to be construed to limit the present invention in all aspects and be considered by way of example. The scope of the present invention should be determined by reasonable interpretation of the accompanying claims and all equivalent modifications made without departing from the present invention should be included in the following claims.

What is claimed is:

1. A method for providing sound from a vehicle to a plurality of wearable devices each having a sound output unit, the method comprising steps of:
retrieving the wearable devices in a wireless manner;
receiving sound input/output setting information from the respective retrieved wearable devices; and
providing sound signals selectively to the respective retrieved wearable devices in a wireless manner based on the received sound input/output setting information.

2. The method according to claim 1, wherein the sound input/output setting information includes at least one of whether an owner of each wearable device is a driver, the position of a passenger, the kind of a function to be used, and a serviceable input/output function.

3. The method according to claim 2, wherein, when a first wearable device among the retrieved wearable devices is judged as belonging to the driver based on the sound input/output setting information, the step of providing the sound signals includes providing navigation guide voice and driving warning sound only to the first wearable device.

4. The method according to claim 3, wherein the providing the navigation guide voice and the driving warning sound is performed regardless of whether media sound is output through a speaker of the vehicle.

5. The method according to claim 2, wherein, when a hands-free function is activated through a second wearable device among the retrieved wearable devices, the step of providing the sound signals includes providing a call sound depending on the hands-free function only to the second wearable device.

6. The method according to claim 5, wherein, when media sound is output through a speaker of the vehicle before the hands-free function is activated, the step of providing the sound signals includes:
muting the speaker of the vehicle; and
providing the media sound to the remaining wearable devices except for the second wearable device among the retrieved wearable devices.

7. The method according to claim 6, wherein the providing the media sound is not performed on the wearable device judged as belonging to the driver based on the sound input/output setting information.

8. The method according to claim 2, further comprising:
receiving a command to control a sound signal from a specific wearable device among the retrieved wearable devices; and
applying sound signal control based on the received control command only to a sound signal to be provided to the specific wearable device.

9. The method according to claim 1, wherein the sound input/output setting information is preset in each of the retrieved wearable devices.

10. The method according to claim 1, wherein each of the steps of retrieving, receiving, and providing are performed via an audio video navigation (AVN) system of the vehicle.

11. A sound provision system of a vehicle for providing sound to a plurality of wearable devices each having a sound output unit, the system comprising:
a wireless communication unit configured to retrieve the wearable devices in a wireless manner; and
a controller configured to control wireless provision of selective sound signals to the respective retrieved wearable devices based on sound input/output setting information received through the wireless communication unit from the respective retrieved wearable devices.

12. The system according to claim 11, wherein the sound input/output setting information includes at least one of whether an owner of each wearable device is a driver, the position of a passenger, the kind of a function to be used, and a serviceable input/output function.

13. The system according to claim 12, wherein, when a first wearable device among the retrieved wearable devices is judged as belonging to the driver based on the received sound input/output setting information, the controller controls navigation guide voice and driving warning sound to be provided only to the first wearable device.

14. The system according to claim 13, further comprising a speaker configured to output media sound,
wherein the controller controls the navigation guide voice and the driving warning sound to be provided only to the first wearable device regardless of whether the media sound is output through the speaker.

15. The system according to claim 12, wherein, when a hands-free function is activated through a second wearable device among the retrieved wearable devices, the controller controls a call sound depending on the hands-free function to be provided only to the second wearable device.

16. The system according to claim 15, further comprising a speaker configured to output media sound,
wherein, when the media sound is output through the speaker of the vehicle before the hands-free function is activated, the controller mutes the speaker of the vehicle and controls the media sound to be provided to the remaining wearable devices except for the second wearable device among the retrieved wearable devices.

17. The system according to claim 16, wherein the controller controls the media sound to be not transmitted to the wearable device judged as belonging to the driver based on the sound input/output setting information.

18. The system according to claim 12, wherein, when a command to control a sound signal is received from a specific wearable device among the retrieved wearable devices, the controller applies sound signal control based on the received control command only to a sound signal to be provided to the specific wearable device.

19. The system according to claim 11, wherein the sound input/output setting information is preset in each of the retrieved wearable devices.

20. The system according to claim 11, wherein the controller is included in an AVN system of the vehicle.

21. A wearable device configured to receive sound from a vehicle, the wearable device comprising:
a sound output unit configured to output sound;
a wireless communication unit to exchange data with the vehicle in a wireless manner; and
a controller configured to transmit sound input/output setting information to the vehicle via the wireless communication unit and to control playback of a selective sound signal through the sound output unit when the selective sound signal based on the sound input/output setting information is received from the vehicle,
wherein the sound input/output setting information includes at least one of whether an owner of each wearable device is a driver, the position of a passenger, the kind of a function to be used, and a serviceable input/output function.
